(19) United States
(12) Patent Application Publication
(10) Pub. No.: US 2013/0229260 A1
(43) Pub. Date: Sep. 5, 2013

(54) ELECTRONIC TAG SYSTEM

(71) Applicant: AU OPTRONICS CORP., Hsin-Chu (TW)

(72) Inventors: Shih-I Huang, Hsin-Chu (TW); Yuan-Hung Chen, Hsin-Chu (TW)

(73) Assignee: AU OPTRONICS CORP., Hsin-Chu (TW)

(21) Appl. No.: 13/759,069

(22) Filed: Feb. 5, 2013

(30) Foreign Application Priority Data
Mar. 2, 2012 (TW) 101106912

(51) Int. Cl. G06F 3/14

(52) U.S. Cl. CPC G06F 3/14
USPC 340/5.91

(57) ABSTRACT

An electronic tag system includes a point of sale host, a client host, a coordinator, a router and an electronic tag group. The point of sale host is configured for transmitting textual data. The client host is configured to provide image data corresponding to the textual data received from the point of sale host. The coordinator is configured for transmitting the image data received from the client host. The router is configured for transmitting the image data received from the coordinator. The electronic tag group includes a plurality of electronic tags for displaying images according to the image data received from the router.

### BACKGROUND

1. Technical Field

The present invention relates to an electronic tag system, especially relating to an electronic tag system having electronic tags capable of updating image data.

2. Description of the Prior Art

Electronic tags are devices configured to show the price or information of products. Electronic tags are usually configured to the shelf and near the corresponding products in a shop or in a grocery store. Compared with traditional tags, when updating displayed information of electronic tags, human power is not required, and the electronic tags do not need to be replaced with another device.

However, when updating the displayed information of electronic tags in a hyper market, a clerk must use a hand-held machine and go near those electronic tags to provide updated information individually. Thus, it is not convenient using relevant updating methods to update electronic tags.

### SUMMARY

An embodiment of the present invention provides an electronic tag system. The electronic tag system includes a point of sale host, a client host, a first coordinator, a first router and a first electronic tag group. The point of sale host is configured for transmitting textual data. The client host is configured for providing corresponding image data according to the textual data received from the point of sale host. The first coordinator is configured for transmitting the image data received from the client host. The first router is configured for transmitting the image data received from the first coordinator. The first electronic tag group includes a plurality of first electronic tags for displaying images respectively according to the image data received from the first router.

Another embodiment of the present invention provides an electronic tag for communicating with a client host through a router and a coordinator. The electronic tag includes a network transmission unit, a counter, a display and a control unit . The network transmission unit is configured for exchanging data with the router. The counter is configured for providing a trigger signal in a predetermined time. The display is configured for displaying an image. The control unit is electrically coupled to the display, the network transmission unit and the counter, for transmitting a request signal to the client host sequentially through the network transmission unit, the router and the coordinator, and updating the image displayed by the display according to received image data.

Another embodiment of the present invention provides a method of updating an electronic tag. The method includes a point of sale host transmitting textual data to a client host, the client host converting the textual data received from the point of sale host into image data, the client host transmitting the image data converted by the client host to an electronic tag group sequentially through a coordinator and a router, and a plurality of electronic tags of the electronic tag group displaying images according to the image data received from the router.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a first embodiment of the electronic tag system of the present invention.

FIG. 2 shows a second embodiment of the electronic tag system of the present invention.

FIG. 3 shows the electronic tag in FIG. 1.

FIG. 4 is a flowchart showing the electronic tag system in FIG. 2 updating data of the electronic tag according to the first embodiment of the present invention.

FIG. 5 is a flowchart showing the electronic tag system in FIG. 2 updating data of the electronic tag according to the second embodiment of the present invention.

FIG. 6 shows a third embodiment of the electronic tag system of the present invention.

FIG. 7 is a flowchart showing the electronic tag system in FIG. 6 updating data of the electronic tag according to the third embodiment of the present invention.

FIG. 8 is a flowchart showing the electronic tag system in FIG. 6 updating data of the electronic tag according to the fourth embodiment of the present invention.

### DETAILED DESCRIPTION

Some phrases are referring to specific elements in the present specification and claims, please notice that the manufacturer might use different terms to refer to the same elements. However, the definition between elements is based on their functions instead of their names. Further, in the present specification and claims, the term “comprising” is open type and should not be viewed as the term “consisted of.” Besides, the term “electrically coupled” may be referring to either directly connecting or indirectly connecting between elements. Thus, if it is described in the below contents of the present invention that a first device is electrically coupled to a second device, the first device may be directly connected to the second device, or indirectly connected to the second device through other devices or means.

The embodiments and figures are provided as follows in order to illustrate the present invention in detail, but please notice that the claimed scope of the present invention is not limited by the provided embodiments and figures.

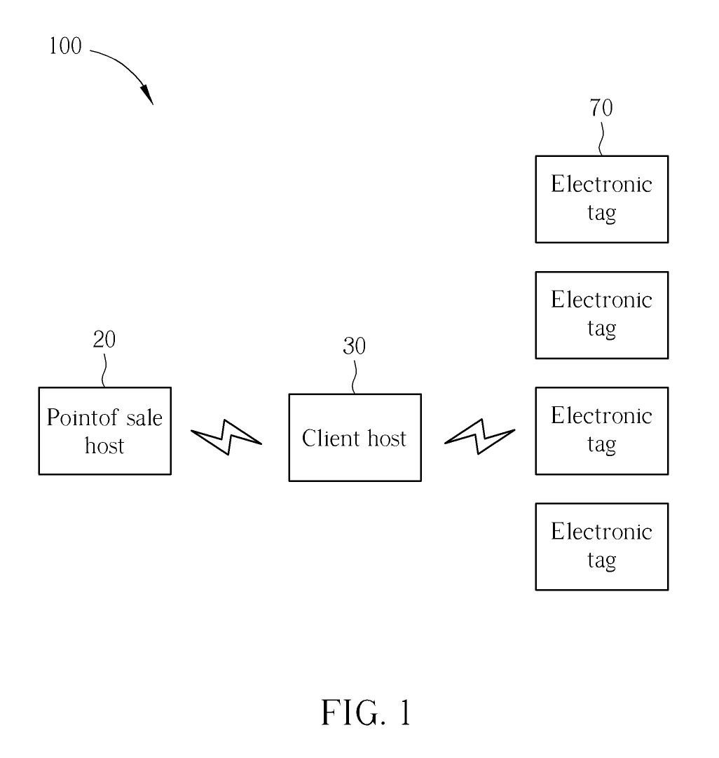

Please refer to FIG. 1, which shows a first embodiment of an electronic tag system 100 of the present invention. The electronic tag system 100 includes a point of sale host 20, a client host 30 and a plurality of electronic tags 70.

When the electronic tag system 100 is operated to update each electronic tag 70, the internet or a local area network is applied to the client host 30 to update and/or transmit information to each electronic tag 70 in broadcasting way, and then each electronic tag 70 selects corresponding updated information among the updated information received from the client host 30. The point of sale host 20 can also control the client host 30 through the internet or a local area network.

Although through applying the aforementioned broadcasting method, the information of each electronic tag 70 maybe successfully updated, thus users can remotely update the name/price of each electronic tag 70 without additional hand held devices or walking near the electronic tags 70 or merchandise. However, because the whole updated information has to be sequentially transmitted to each electronic tag 70, the data transmission amount may be too large and the total transmission time may be too long. Besides, when using the aforementioned broadcasting method, the electronic tags 70 have to keep in an awakened state, increasing power dissipation. Further, because the power of the electronic tags 70 maybe supplied by built-in mercury batteries, frequently replacing the built-in mercury batteries due to keeping the built-in mercury batteries in the awakened state will waste more resources and do more harm to the environment.

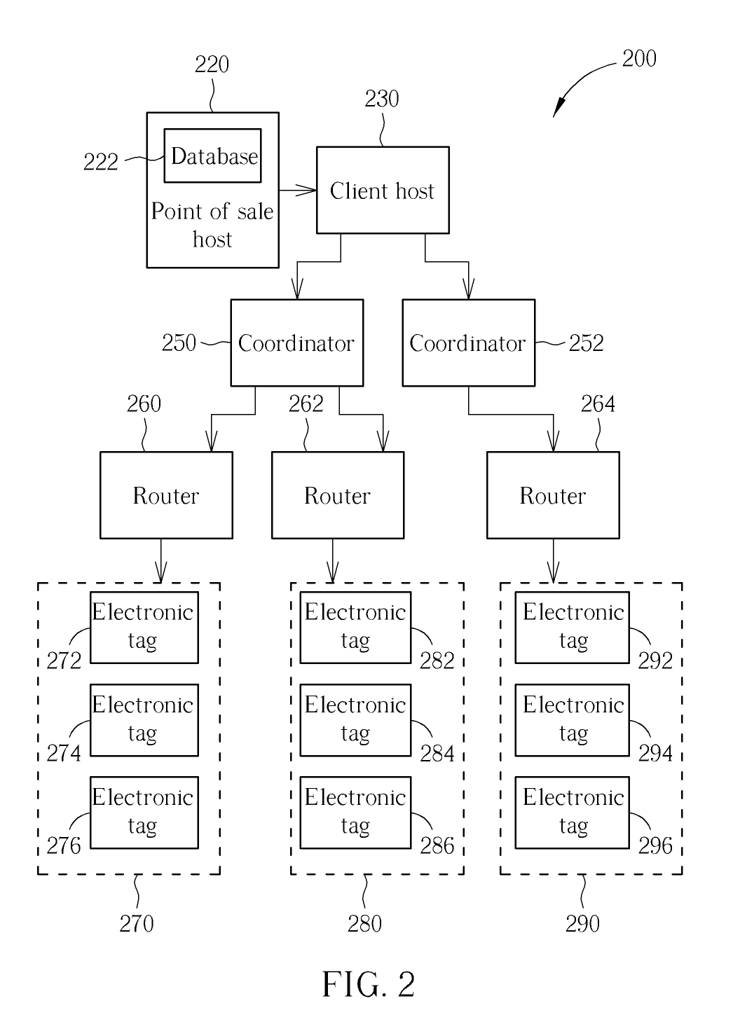

FIG. 2 shows as a second embodiment of an electronic tag system 200 of the present invention. As shown in FIG. 2, the electronic tag system 200 comprise a point of sale host 220, a client host 230, coordinators 250 and 252, routers 260, 262 and 264, and electronic tag groups 270, 280 and 290. The point of sale host 220 is configured to transmit textual data to the client host 230 such that the client host 230 provides image data corresponding to the received textual data. The coordinators 250 and 252 are configured to receive and then transmit the image data transmitted by the client host 230. The routers 260, 262 and 264 are configured to transmit the image data received from the coordinator 250. For example, when configuring the electronic tag system 200 in a shopping mall having multiple floors, the coordinator 250 and the routers 260 and 262 may be configured on the first floor, and the coordinator 252 and the router 264 may be configured on the second floor. Thus, it can be avoided that one of the coordinators 250 and 252 loses connection with the client host 230 because the coordinators 250 and 252 are interfering with each other because they are too close to each other.

For example, the point of sale host 220 maybe a database system configured in the company of hypermarkets or convenience stores by its business owner. The prices of merchandise or any other information required by electronic tags may be all stored in the database system to ensure safety and to be easily managed, and the point of sale host 220 can communicate with the client host 230 through the internet or a local area network. The client host 230 may be a server set in a branch of a hypermarket or a convenience store by the business owner, and the client host 230 can communicate with the point of sale host 220, the coordinators at a same sales point and/or the coordinators belonging to the client host 230. Besides, the communication between the coordinators 250, 252, the routers 260, 262, 264 and the electronic tags can also utilize the internet or a local area network. The aforementioned internet or local area network maybe a wired network or a wireless network such as, inter alia, a Zigbee communication protocol, Wifi (wireless fidelity) communication protocol, LTE communication protocol, ether network or Wimax communication protocol.

Besides, the textual data may be prices, names or related information of merchandise recorded in texts such as characters or numbers. However, the textual data may have to be transformed into images or icons for the electronic tag groups 270, 280 and 290 to display.

Please refer to the FIG. 2 again. The electronic tag group 270 comprises electronic tags 272, 274 and 276, the electronic tag group 280 comprises electronic tags 282, 284 and 286, and the electronic tag group 290 comprises electronic tags 292, 294 and 296. For example, the client host 230 may be a client host in a convenience store, the electronic tag group 270 may be an electronic tag for frozen foods, the electronic tag group 280 maybe an electronic tag for stationary, and electronic tag group 290 may be an electronic tag for drinks. The above sort is just a demonstration, not a limitation.

The electronic tag groups 270, 280 and 290 are configured to respectively receive image data respectively from the routers 260, 262 and 264 in order to display images. The image data are images generated according to the textual data and are displayed by electronic tags. The point of sale host 220 comprises a database 222 for storing and providing data.

Though each of the electronic tag groups 270, 280 and 290 only includes three electronic tags in FIG. 2, the embodiment of the present invention does not limit the number of the electronic tags in an electronic tag group. Similarly, the numbers of the client host 230, coordinators 250 and 252, routers 260, 262 and 264 may be determined according to actual needs and are not limited by the illustration in FIG. 2.

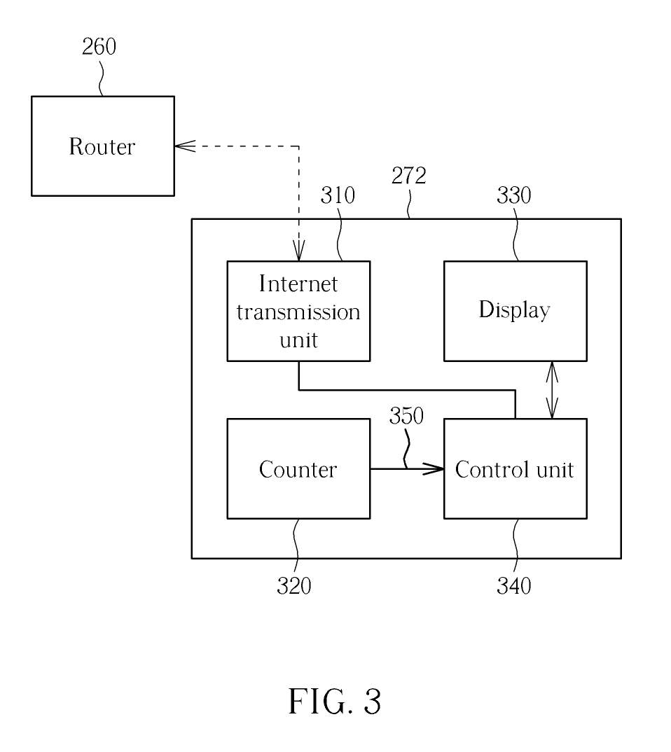

Each electronic tag in the electronic tag groups 270, 280 and 290 includes an internet transmission unit, a counter, a display and a control unit. Please refer to FIG. 3 that shows the electronic tag 272 in FIG. 1. As shown in FIG. 3, the electronic tag 270 includes an internet transmission unit 310, a counter 320, a display 330 and a control unit 340. The internet transmission unit 310 is configured to switch data with the router 260 and for exchanging data with the router. The counter 320 is configured to provide trigger signal at preset time to wake up the electronic tag 272 from a sleeping status to an operating status . The display 330 is configured to display images. The control unit 340 is electrically connected to the display 330, the internet transmission unit 310 and the counter 320 for transmitting a request signal to the client host 230 sequentially through the network transmission unit 310, the router 260 and the coordinator 250, and updating the image displayed by the display 330 according to the received image data. The control unit 340 is configured to control the electronic tag 270 to receive image data from the client host 230 sequentially through the coordinators 250, 260 and the internet transmission unit 310, and then to update the images displayed by the display 330 according to the received image data. Moreover, the control unit 340 also configure to transmit a request signal to the client host sequentially through the network transmission unit, the router and the coordinator.

The display 330 may be a reflection type display, a liquid crystal display, an organic light emitting diode display, an electrophoresis display (EPD)or an electronic paper configured to display images. The counters 320 in each of the electronic tags 272, 274 and 276 can provide a trigger signal substantially at the same time to wake up the electronic tags 272, 274 and 276 from a sleeping status to an operating status substantially at the same time so that the electronic tags 272, 274 and 276 are capable of synchronously receiving the corresponding updating data received from the router 260.

When the electronic tags 272, 274 and 276 are receiving the corresponding updating data from the router 260, an individual identification code of the electronic tag 272 will be compared with an identification code of the updating data to insure that the electronic tag 272 is updated according to the image data belonging to the electronic tag 272, not according to image data belonging to the electronic tag 274 or 276. Similarly, each of the electronic tags 274 and 276 also has an individual identification code to be compared with the identification code of the updating data to insure that the electronic tags 274 and 276 are updated according to image data respectively belonging to the electronic tags 274 and 276, not according to the image data belonging to other electronic tags. On the other hand, when the router 262 receives the updating data belonging to the electronic tags 272, 274 and 276 from the coordinator 250, the router 262 will not transmit those updating data to the electronic tags 272, 274 and 276, and will directly delete those updating data, because the updating data belonging to the electronic tags 272, 274 and 276 should be transmitted by the router 260, not the router 262.

The electronic tags 272, 274 and 276 in the electronic tag group 270 can be synchronously updated after receiving the image data, the electronic tags 282, 284 and 286 in the electronic tag group 280 can be synchronously updated after receiving the image data, and the electronic tags 292, 294 and 296 in the electronic tag group 290 can be synchronously updated after receiving the image data. However, the electronic tags in the electronic groups 270, 280 and 290 can respectively update the images displayed by the respective display 330, and do not need to wait for other electronic tags in the same electronic group.

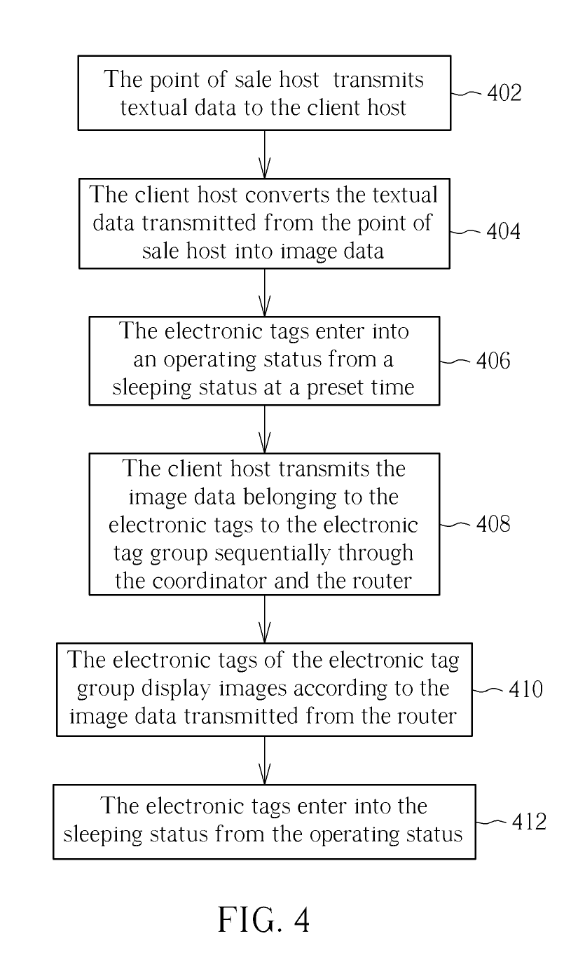

Please refer to FIG. 4, which is a flowchart showing the electronic tag system 200 in FIG. 2 updating data of the electronic tag 272 according to the first embodiment of the present invention. The descriptions are as follows.

Step 402: transmit textual data from the point of sale host 220 to the client host 230;

Step 404: convert the textual data received from the point of sale host 220 into image data with the client host 230;

Step 406: control the electronic tags 272, 274 and 276 to enter into an operating status from a sleeping status at a preset time;

Step 408: transmit the image data belonging to the electronic tags 272, 274 and 276 to the electronic tag group 270 sequentially through the coordinator 250 and the router 260 with the client host 230;

Step 410: display images according to the image data received from the router 260 with the electronic tags 272, 274 and 276 of the electronic tag group 270.

Step 412: control the electronic tags 272, 274 and 276 to enter into the sleeping status from the operating status.

Step 406 is performed before Step 408, so that the client host 230 can transmit the image data belonging to the electronic tags 272, 274 and 276 to the electronic tag group 270 sequentially through the coordinator 250 and the router 260. Step 412 can be immediately performed after performing Step 410 to reduce the power consumption of the electronic tags 272, 274 and 276. Besides, the router 260 only needs to update the electronic tags 272, 274 and 276, the router 262 only needs to update the electronic tags 282, 284 and 286, the router 264 only needs to update the electronic tags 292, 294 and 296, the coordinator 250 only needs to update the routers 260 and 262, and the coordinator 252 only need to update the router 264.

Therefore, when the electronic tag group 270 is the only one electronic tag group needing to be updated, the client host 230 merely needs to transmit image data belonging to the electronic tags 272, 274 and 276 to the electronic tags 272, 274 and 276 sequentially through the coordinator 250 and the router 260, thus the electronic tags 272, 274 and 276 will receive the image data belonging to the electronic tags 272, 274 and 276, respectively, and will not receive the image data belonging to the electronic tags 282, 284, 286, 292, 294 and 296. Further, since the electronic tag 272 will not receive the image data belonging to the electronic tags 282, 284, 286, 292, 294 and 296, the electronic tag 272 only has to delete the image data belonging to the electronic tags 274 and 276, and does not need to delete the image data belonging to the electronic tags 282, 284, 286, 292, 294 and 296. That is, the router 264 is configured for blocking the image data belonging to the electronic tags 272, 274, 276, 282, 284 and 286 from being transmitted to the electronic tags 292, 294 and 296.

In relevant methods, the client host 30 transmits all of the updating information to each of the electronic tags 70 in a broadcasting way, and then each of the electronic tag 70 selects the updating information belonging to the electronic tag 70 from all of the updating information received from the client host 30 and deletes the updating information belonging to other electronic tags 70. Thus, comparing with relevant methods, the first embodiment of the present invention can greatly reduce required time and amount of deleting the updating data of the electronic tag 272, and further reduce the power consumption through the electronic tag 272 entering into a sleeping status.

The electronic tags 272, 274, 276, 282, 284, 286, 292, 294 and 296 can decide when to enter into the sleeping status and when to entering into the operating status. For example, if a convenience store updates the prices/names of the electronic tags 272, 274 and 276 but does not update the prices/names of the electronic tags 282, 284 and 286, the electronic tags 272, 274 and 276 are set to enter into the operating status at 5:00 to 6:00 AM and to enter into the sleeping status at other time, and the electronic tags 282, 284, 286, 292, 294 and 296 are set to enter into the operating status from the sleeping status only when requiring to be updated, thus reducing the power consumption of the electronic tag groups 270, 280 and 290.

However, the electronic tags 272, 274 and 276 may be set to enter into the sleeping status at the time right after the electronic tags 272, 274 and 276 and before 6:00 PM, and to enter into the operating status again at 5:00 AM of the next day to further reduce the power consumption.

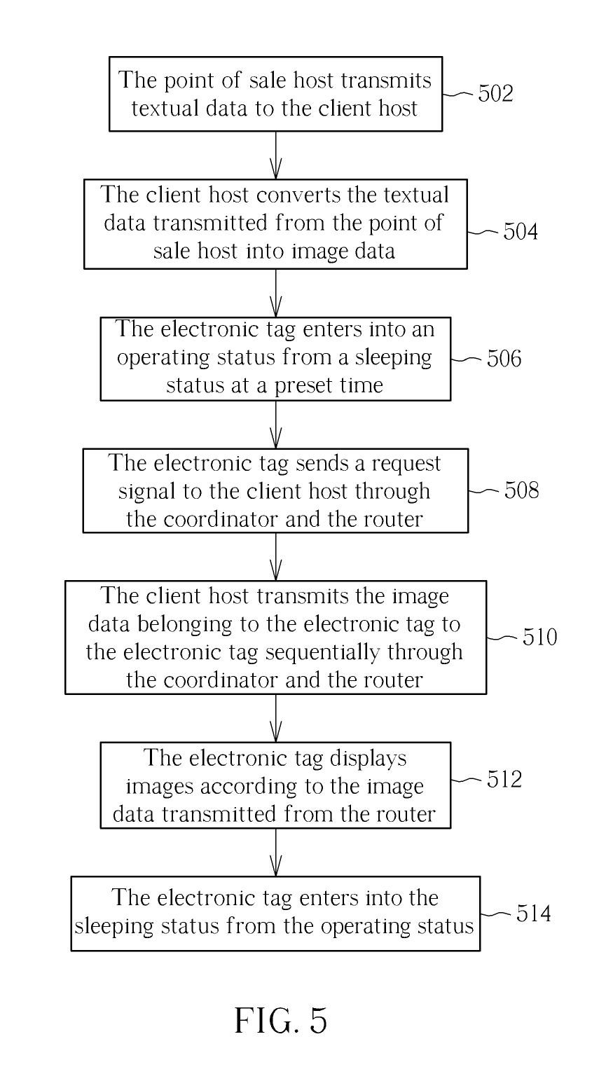

Please refer to FIG. 5 that is a flowchart showing the electronic tag system 200 in FIG. 2 updating data of the electronic tag 272 according to the second embodiment of the present invention. The descriptions are as follows.

Step 502: transmit textual data to the client host 230 with the point of sale host 220;

Step 504: convert the textual data received from the point of sale host 220 into image data with the client host 230;

Step 506: control the electronic tag 272 to enter into an operating status from a sleeping status at a preset time;

Step 508: send a request signal to the client host 230 through the coordinator 250 and the router 260 with the electronic tag 272;

Step 510: transmits the image data belonging to the electronic tag 272 to the electronic tag 272 sequentially through the coordinator 250 and the router 260 according to the request signal with the client host 230;

Step 512: display images according to the image data received from the router 260 with the electronic tag 272.

Step 514: control the electronic tag 272 to enter into the sleeping status from the operating status.

The difference between the second embodiment in FIG. 5 and the first embodiment in FIG. 4 is that in the second embodiment, the request signal of a single electronic tag 272 is considered, so that the image data belonging to the electronic tag 272 may be sent to the electronic tag 272 singly. The request signal is configured to inform the client host 230 that the electronic tag 272 has entered into the operating status from the sleeping status and is about to update the displayed image. Thus, the client host 230 sends the updating image data after receiving the request. Therefore, when the electronic tag 272 is the only electronic tag in the electronic tag group 270 that needs to be updated, the client host 230 merely needs to transmit the image data belonging to the electronic tag 272 to the electronic tag 272 sequentially through the coordinator 250 and the router 260 without transmitting the image data belonging to the electronic tags 274 and 276, thus the electronic tag 272 will not receive the image data belonging to the electronic tags 274 and 276. Further, since the electronic tag 272 will not receive the image data belonging to the electronic tags 274 and 276, the electronic tag 272 does not need to delete the image data belonging to the electronic tags 272, 274, 282, 284, 286, 292, 294 and 296.

Comparing with the first embodiment, the second embodiment further reduces the time required to delete the image data belonging to the electronic tags 274 and 276, and reduces the time of receiving the updating data to make the electronic tag 272 enter into the sleeping status earlier to further reduce power consumption. Besides, if the electronic tags 274 and 276 are in the operating status while the electronic tag 272 is receiving the updating data, the electronic tags 274 and 276 will also receive the updating data belonging to the electronic tag 272. After that, the electronic tags 274 and 276 will delete the received updating data belonging to the electronic tag 272. On the contrary, if the electronic tags 274 and 276 are in the sleeping status, the electronic tags 274 and 276 will not receive the updating data belonging to the electronic tag 272. In Step 514, the electronic tag 272 can enter into the sleeping status from the operating status right after being updated to reduce the power consumption.

In Steps 402 to 412 and Steps 502 to Steps 214, the textual data, image data or request signal is often transmitted/received wirelessly, however, the textual data, image data or request signal may also be transmitted/received wiredly.

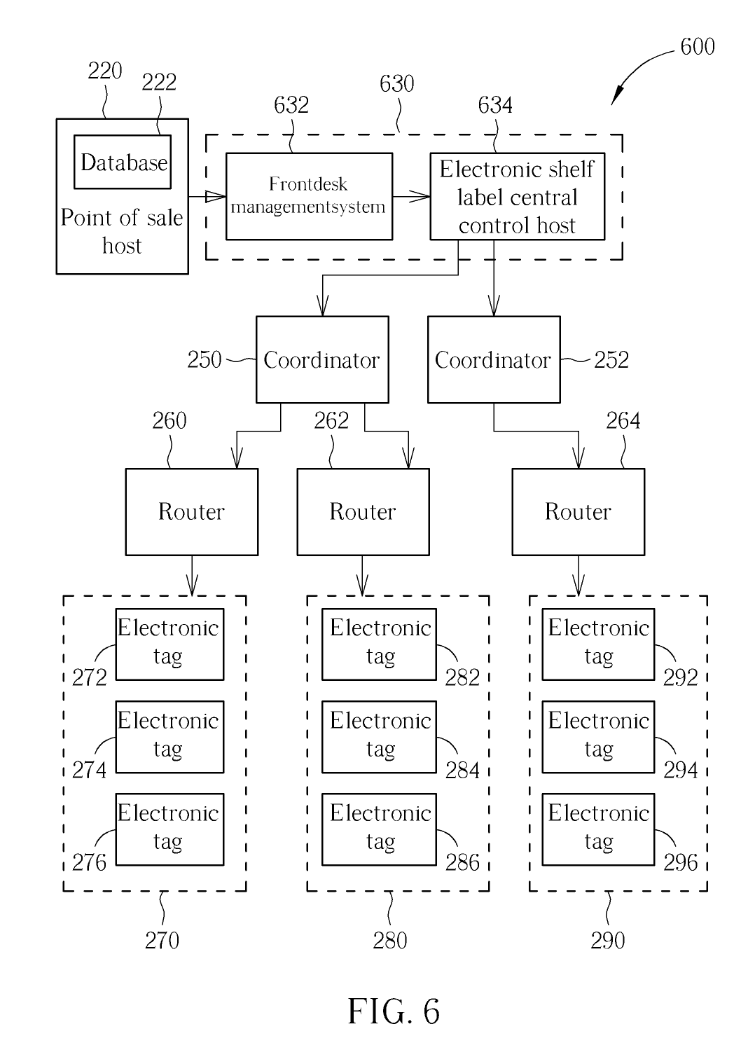

Please refer to FIG. 6, which shows a third embodiment of an electronic tag system 600 of the present invention. The difference between the electronic tag systems 200 and 600 is that the client host 630 of the electronic tag system 600 comprises a front desk management system 632 and an electronic shelf label central control host 634. The front desk management system 632 is configured for receiving the textual data from the point of sale host 220. The electronic shelf label central control host 634 is configured for providing image data according to the textual data received from the front desk management system 632. Besides, the front desk management system 632 can communicate with the electronic shelf label central control host 634 through a local area network or the internet. The front desk management system 632 may also directly connect to the electronic shelf label central control host 634 with a transmission line. Moreover, the front desk management system 632 may be a cash register set in a point of sale or the branches of the point of sale, and the electronic shelf label central control host 634 may be a host set in the point of sale or the branches of the point of sale for controlling the electronic tags of the point of sale or the branches of the point of sale.

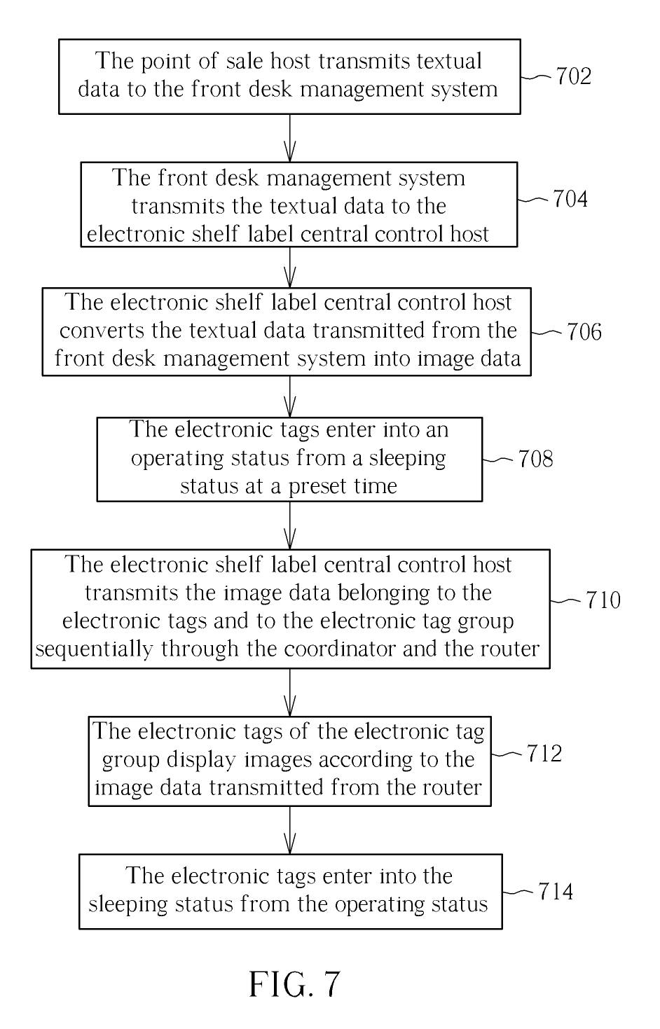

Please refer to FIG. 7 that is a flowchart showing the electronic tag system 600 in FIG. 6 updating data of the electronic tag 272 according to the third embodiment of the present invention. The descriptions are as follows.

Step 702: transmit textual data to the front desk management system 632 with the point of sale host 220;

Step 704: transmits the textual data to the electronic shelf label central control host 634 with the front desk management system 632;

Step 706: convert the textual data received from the front desk management system 632 into image data with the electronic shelf label central control host 634;

Step 708: control the electronic tags 272, 274 and 276 to enter into an operating status from a sleeping status at a preset time;

Step 710: transmit the image data belonging to the electronic tags 272, 247 and 276 to the electronic tag group 270 sequentially through the coordinator 250 and the router 260 with the electronic shelf label central control host 634;

Step 712: display images according to the image data received from the router 260 with the electronic tags 272, 274 and 276 of the electronic tag group 270.

Step 714: control the electronic tags 272, 274 and 276 to enter into the sleeping status from the operating status.

Step 708 is performed before Step 710, so that electronic shelf label central control host 634 can transmit the image data belonging to the electronic tags 272, 274 and 276 to the electronic tag group 270 sequentially through the coordinator 250 and the router 260. Step 714 maybe immediately performed after performing Step 712 to reduce the power consumption of the electronic tags 272, 274 and 276. Besides, the router 260 only needs to update the electronic tags 272, 274 and 276, the router 262 only needs to update the electronic tags 282, 284 and 286, the router 264 only needs to update the electronic tags 292, 294 and 296, the coordinator 250 only needs to update the routers 260 and 262, and the coordinator 252 only needs to update the router 264. Therefore, when the electronic tag group 270 is the only electronic tag group needing to be updated, the client host 230 merely needs to transmit image data belonging to the electronic tags 272, 274 and 276 to the electronic tags 272, 274 and 276 sequentially through the coordinator 250 and the router 260, thus the electronic tags 272, 274 and 276 will receive the image data belonging to the electronic tags 272, 274 and 276, respectively, and will not receive the image data belonging to the electronic tags 282, 284, 286, 292, 294 and 296. Further, since the electronic tag 272 will not receive the image data belonging to the electronic tags 282, 284, 286, 292, 294 and 296, the electronic tag 272 only has to delete the image data belonging to the electronic tags 274 and 276, and does not need to delete the image data belonging to the electronic tags 282, 284, 286, 292, 294 and 296. Thus, comparing with relevant methods, the third embodiment of the present invention can greatly reduce required time and amount of deleting the updating data of the electronic tag 272, and further reduce the power consumption in Step 714 through the electronic tag 272 entering into a sleeping status immediately after being updated.

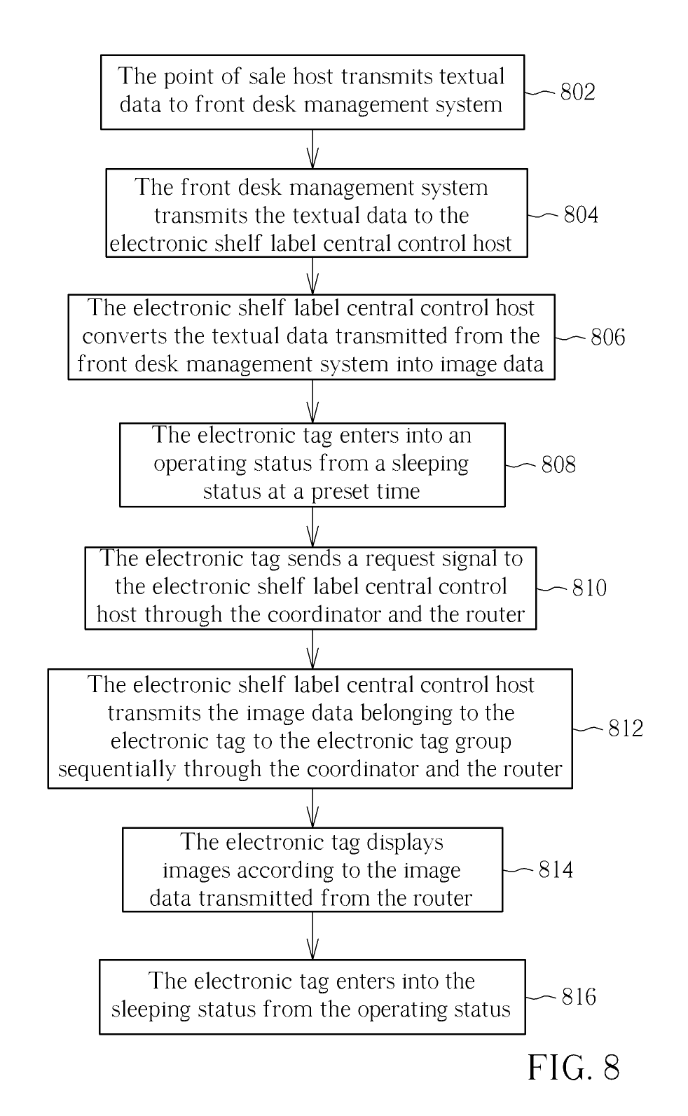

Please refer to FIG. 8 that is a flowchart showing the electronic tag system 600 in FIG. 6 updating data of the electronic tag 272 according to the fourth embodiment of the present invention. The descriptions are as follows.

Step 802: transmit textual data to front desk management system 632 with the point of sale host 220;

Step 804: transmit the textual data to the electronic shelf label central control host 634 with the front desk management system 632;

Step 806: convert the textual data received from the front desk management system 632 into image data with the electronic shelf label central control host 634;

Step 808: control the electronic tag 272 to enter into an operating status from a sleeping status at a preset time;

Step 810: send a request signal to the electronic shelf label central control host 634 through the coordinator 250 and the router 260 with the electronic tag 272;

Step 812: transmit the image data belonging to the electronic tag 272 to the electronic tag group 270 sequentially through the coordinator 250 and the router 260 with the electronic shelf label central control host 634;

Step 814: display images according to the image data received from the router 260 with the electronic tag 272.

Step 816: control the electronic tag 272 to enter into the sleeping status from the operating status.

In the above Steps, when the electronic tag 272 is the only electronic tag in the electronic tag group 270 that needs to be updated, the electronic shelf label central control host 634 merely needs to transmit the image data belonging to the electronic tag 272 to the electronic tag sequentially through the coordinator 250 and the router 260 without transmitting the image data belonging to the electronic tags 274 and 276, thus the electronic tag 272 will not receive the image data belonging to the electronic tags 274 and 276. Thus comparing with the first embodiment, the fourth embodiment further reduces the time required to delete the image data belonging to the electronic tags 274 and 276, and reduces the time of receiving the updating data to make the electronic tag 272 enter into the sleeping status earlier to further reduce power consumption. Besides, if the electronic tags 274 and 276 are in the operating status while the electronic tag 272 is receiving the updating data, the electronic tags 274 and 276 will also receive the updating data belonging to the electronic tag 272. After that, the electronic tags 274 and 276 will delete the received the updating data belonging to the electronic tag 272. On the contrary, if the electronic tags 274 and 276 are in the sleeping status, the electronic tags 274 and 276 will not receive the updating data belonging to the electronic tag 272. In Step 816, the electronic tag 272 can enter into the sleeping status from the operating status right after being updated to reduce the power consumption.

In Steps 702 to 714 and Steps 802 to Steps 816, the textual data, image data or request signal is often transmitted/received wirelessly, however, the textual data, image data or request signal may also be transmitted/received wiredly.

According to the devices and methods of the embodiments of the present invention, users can remotely update the prices/names electronic tags without additional hand-held device or walking to approach the electronic tags or merchandise. Besides, in the electronic tag systems 200 and 600, when only a part of electronic tag groups or electronic tags need to be updated, those electronic tag groups or electronic tags may be individually updated instead of sequentially updating every electronic tag group or electronic tags in a broadcasting way, thus greatly reducing the time and the transmission amount of updating. Moreover, through configuring the counter 320 inside the electronic tag, the timing of the electronic tag entering into the sleeping status and operating status may be controlled, thus further reducing the power consumption of the electronic tag.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic tag system, comprising:
a point of sale host for transmitting textual data;
a client host for providing corresponding image data according to the textual data received from the point of sale host;
a first coordinator for transmitting first image data received from the client host;
a first router for transmitting the first image data received from the first coordinator; and
a first electronic tag group comprising a plurality of first electronic tags for displaying images respectively according to the first image data received from the first router.

2. The electronic tag system of claim 1, wherein the client host comprises:
a front desk management system for receiving the textual data received from the point of sale host; and
an electronic shelf label central control host, for providing the corresponding image data according to the textual data received from the front desk management system.

3. The electronic tag system of claim 1, further comprising:
a second router for communicating with the first coordinator and transmitting second image data received from the first coordinator; and
a second electronic tag group comprising a plurality of second electronic tags, each second electronic tag is configured for receiving the second image data from the second router, and displaying second images respectively according to the second image data received from the second router.

4. The electronic tag system of claim 3, further comprising:
a second coordinator for transmitting third image data received from the client host;
a third router for transmitting the third image data received from the second coordinator; and
a third electronic tag group, comprising a plurality of third electronic tags, wherein each third electronic tag is configured for receiving the third image data from the third router, and displaying third images respectively according to the third image data received from the third router.

5. The electronic tag system of claim 4, wherein:
the first electronic tags are configured to update synchronously after receiving the first image data;
the second electronic tags are configured to update synchronously after receiving the second image data;
the third electronic tags are configured to update synchronously after receiving the third image data; and
the point of sale host comprises a data base.

6. The electronic tag system of claim 5, wherein:
the first electronic tags are configured to enter into the sleeping status after updating;
the second electronic tags are configured to enter into the sleeping status after updating; and
the third electronic tags are configured to enter into the sleeping status after updating.

7. The electronic tag system of claim 3, wherein the second router is configured for blocking the first image data from being transmitted to the plurality of second electronic tags.

8. The electronic tag system of claim 1, wherein each first electronic tag comprises:
a network transmission unit for exchanging data with the first router;
a counter for providing a trigger signal at a predetermined time;
a display for displaying one of the first images; and
a control unit, electrically coupled to the display, the network transmission unit and the counter, for transmitting a request signal to the client host sequentially through the network transmission unit, the first router and the first coordinator, and updating the image displayed by the display according to the received first image data.

9. The electronic tag system of claim 1, wherein the textual data comprises prices, names or related information of merchandise recorded in texts.

10. An electronic tag for communicating a client host through a router and a coordinator, the electronic tag comprising:
a network transmission unit for exchanging data with the router;
a counter for providing a trigger signal at a predetermined time;
a display for displaying an image; and
a control unit, electrically coupled to the display, the network transmission unit and the counter, for transmitting a request signal to the client host sequentially through the network transmission unit, the router and the coordinator, and updating the image displayed by the display according to received image data.

11. A method of updating an electronic tag, comprising:
transmitting textual data from a point of sale host to a client host;
converting the textual data received from the point of sale host into first image data with the client host;
transmitting the first image data generated by the client host from the client host to a first electronic tag group sequentially through a first coordinator and a first router; and
displaying first images respectively according to the first image data received from the first router on a plurality of first electronic tags of the first electronic tag group.

12. The method of claim 11, wherein:
transmitting the textual data from the point of sale host to the client host comprises transmitting the textual data from the point of sale host to an electronic shelf label central control host of the client host through a front desk management system of the client host;
converting the textual data received from the point of sale host into first image data with the client host comprises converting the textual data received from the front desk management system into the first image data with the electronic shelf label central control host; and
transmitting the first image data generated by the client host from the client host to the first electronic tag group sequentially through the first coordinator and the first router comprises transmitting the first image data generated by the electronic shelf label central control host to the first electronic tag group sequentially through the first coordinator and the first router with the electronic shelf label central control host.

13. The method of claim 12, further comprising:
outputting a request signal to the electronic shelf label central control host through the router and the first coordinator with an first electronic tag of the first electronic tag group;
wherein transmitting the first image data generated by the electronic shelf label central control host to the first electronic tag group sequentially through the first coordinator and the first router with the electronic shelf label central control host, is transmitting the first image data belonging to the first electronic tag to the first electronic tag group sequentially through the first coordinator and the first router after receiving the request signal with the electronic shelf label central control host.

14. The method of claim 12, further comprising:
controlling the electronic tag to enter into an operating status from a sleeping status; and
controlling the electronic tag to enter into the sleeping status from the operating status.

15. The method of claim 11, further comprising:
outputting a request signal to the client host through the first router and the first coordinator with an first electronic tag of the first electronic tag group;
wherein transmitting the first image data generated by the client host from the client host to the first electronic tag group sequentially through the first coordinator and the first router, is transmitting the first image data belonging to the first electronic tag to the first electronic tag group sequentially through the first coordinator and the first router after receiving the request signal.

16. The method of claim 11, wherein transmitting the first image data generated by the client host from the client host to the first electronic tag group sequentially through the first coordinator and the first router, is wiredly or wirelessly transmitting the image data belonging to the electronic tags to the electronic tag group sequentially through the coordinator and the router.

17. The method of claim 11, further comprising:
controlling the electronic tag to enter into an operating status from a sleeping status; and
controlling the electronic tag to enter into the sleeping status from the operating status.

18. The method of claim 11, wherein the textual data comprises prices, names or related information of merchandise recorded in texts.

19. The method of claim 11, further comprising:
blocking the plurality of first electronic tags from receiving image data not belonging to the first image data.

20. The method of claim 11, further comprising configuring the first electronic tags to enter into the sleeping status after updating.
